(19) United States
(12) Patent Application Publication
(10) Pub. No.: US 2002/0026426 A1
(43) Pub. Date: Feb. 28, 2002

(54) Method of accessing the internet via the use of automated teller machines

(76) Inventor: Joseph Michael Bennett, Dayton, OH (US)

Correspondence Address: Joseph Michael Bennett, 5722 Craigmont Court, Dayton, OH, 45424, US

(21) Appl. No.: 09/920,512

(22) Filed: Aug. 1, 2001

Related U.S. Application Data
(60) Provisional application No. 60/227,547, filed on Aug. 24, 2000.

(51) Int. Cl. G06F 15/16; G06F 17/60; H04L 9/00; H04K 1/00

(52) U.S. Cl. 705/64; 709/218; 705/35

(57) ABSTRACT

A means to access the Internet, World Wide Web and other financial institutions and databases via use of an Automated Teller Machine (ATM) or Point-of-Sale (POS) terminal, and the terminal's keypads, menu keys, video screen, video cameras, data transmission lines, and other means. Electronic software programming is configured to facilitate access to these databases via the terminal by means of input supplied by an operator to the various listed input devices, such as the keypads, menu keys, and video cameras. Output from the databases is supplied by the terminal video screen or paper printer. Such data accessed by the operator via the terminal may comprise sports scores, weather, stock quotes, travel directions, flight schedules, email access, real-time communication with another remote operator, song selection, Internet access, financial services, movie and show listings and show times. Email messages may be sent and received at the terminal site and reviewed via the terminal screen, and entered and transmitted by the operator via use of the terminal keypad. Email messages, and other legal documents such as cashier's checks, traveler's checks, data from existing databases, lottery or raffle tickets, food stamps, coupons, movie or show tickets can be printed from the paper printer. A video camera, either a pre-existing security camera or additional camera, may be used to transmit images from the site of the terminal to another remote site. These value-added services can be charged to the operator on the account represented by the credit card, debit card, ATM card or special access card inserted by the operator in the terminal card reader.

This disclosure was originally filed as Provisional Patent Application No. 60/227,547, Aug. 24, 2000.

### BACKGROUND OF THE INVENTION

1. Field of the Invention

The present invention relates to an automated teller machine (ATM) or point-of-sale (POS) electronic terminal. More specifically, the present invention relates to an expansion of the features and capabilities of an ATM or POS terminal via electronic programming enhancements, to permit user access to “surf” the Internet, the World Wide Web and its various sources of data, review, send and print out email messages, and download and receive paper copies of other data such as travel directions, flight times, stock quotes and many other paper documents. These enhancements are added without the need to modify the physical configuration of existing ATM or POS terminals, to minimize cost of retrofit and to increase the profitability of the owners of existing ATM and POS networks.

2. Related Art

Automated teller machine (ATM) and Point-of-Sale (POS) terminals only perform services and accrue service charges when they are placed in action while a user is performing a financial transaction. For the remainder and overwhelming majority of the time, the terminal is unused and therefore not generating revenue. For example, a typical modestly successful terminal may be used approximately 200 times per month, requiring an estimated 200 minutes of use per month—with the remaining time residing idle. Since rental and equipment, amortization expenses, insurance and service fees are charged on a monthly basis regardless of amount of use, it behooves an owner of an ATM/POS network to maximize the time that such terminals are in service performing charge and revenue-generating tasks, to optimize the chance for profitable operations and to maximize such profits. Unfortunately, relatively few practical ideas have been proposed and initiated to expand the range of products offered and amount of total terminal usage. In addition, for existing ATM/POS networks, any required hardware modifications to the numerous terminals normally present in any network would involve equipment and manpower expenses that would greatly dilute or negate any profits possible with the new revenue-generating features incorporated into the terminals.

Many individuals, particularly business travelers, desire or need access to information when at a hotel or at a remote site. Such information could include flight reservations and the latest departure schedules, weather, movie and show times and offerings, sports scores and news. In addition, one would desire access to email messages at a remote site, and a means to send them. Although some of this information may be available to travelers with modem portable electronic devices, such information may be limited or sporadic in availability when using such devices, and such access is typically quite expensive to obtain, due to the cost of the equipment and the cost of data access services. Users typically will want such information at a convenient time and place without the need for transporting equipment, and at minimal cost based only upon the amount of usage. Other financial documents such as cashier's checks and traveler's checks may be desired, particularly at the site of a major purchase such as a car, or for a traveler at a restaurant or one who has lost their traveler's checks.

Vajk, et al (U.S. Pat. No. 5,265,033) discloses a means of sending and receiving electronic “email” from and ATM or POS terminal. It was stated in the specification that the intent of this ability was to improve the access of email capabilities to a wider portion of the public, which was disclosed at a time when the access of the public to the Internet and other computer networks was minimal. Such an arrangement using these public terminals might have been the only way for many in the public to have such access. The disclosure expressed sending and possibly receiving email messages at the terminal site. A credit card or other card was needed to be inserted in the terminal to confirm the identity of the operator and recipient. A charge for the service was applied to the user's financial institution. Messages could be sent from the terminal to a remote fax machine or pager. As disclosed, the variety of messages to be sent would be chosen from (1) a series of generic messages available at the terminal site, (2) a message stored on a computer chip embedded in the user's access card, or (3) written down on a “pen-pad” arrangement at the terminal site, with an additional optical character recognition device added.

Although the potential to assess a service charge to the user at the user's financial service institution was disclosed, no mention was made of charging the fee directly to an inserted credit card (which apparently was only used as a user identity verification means in the disclosure), as opposed to a remote bank account arrangement. No mention was made of printing out an email message at the terminal using the existing paper receipt device. No mention was made of composing a custom email message from the existing terminal keypad to send.

Grossi, et al (U.S. Pat. No. 5,604,341) discloses a means of using ATM terminals as sites to conduct video conferences with other ATMs or other video conference sites, such as a personal computer. Such arrangements required the installation and use of audio speakers, microphones and video cameras to the terminal site. It was not disclosed to use the existing video security camera for this purpose.

Gallacher, et al (U.S. Pat. No. 5,901,204) discloses a means of downloading a single video image and a short audio segment digitally from a remote library to an ATM. If the video image and audio downloaded prompted the operator to see more, a full video and audio clip could then be downloaded.

Clark, et al (U.S. Pat. No. 5,918,748) discloses a means for an ATM to receive deposits of paper currency and checks from a user. The ATM has a means to sort the currency and checks, and confirm the number of items, both currency bills and checks, that were deposited. These numbers are reported back to the user on a paper receipt, as opposed to only reporting the total number of items (both currency and checks) as with prior art. Additional sorting can be performed by an optional imaging device.

Schneider, et al (U.S. Pat. No. 5,929,897) discloses a means for an ATM terminal user to initiate a transaction with a branch of a financial institution. The actions initiated from the terminal are transmitted to the institution, where a means is present to locate an available financial officer, who is notified of the request. The available officer then takes action to complete the connection and establish a direct video conference with the ATM user. The communications means was disclosed thereafter as comprising a video conference means of communication. Video cameras (and presumably microphones) would be required at both sites to conduct such video conferences.

Mankovitz (U.S. Pat. No. 5,949,492) discloses a means of transmitting additional broadcast channels of information that relate and are in concert with radio and television broadcast transmissions. Such channels must be received by other electronic and hardware means such as readers and display windows. These receivers would be built and integrated into radios, televisions, ATMs, and other equipment. The data transmitted on these supplemental channels would provide information concerning the time, broadcast station and possibly other information, such as the artist and song title for radio broadcasts. The Internet was mentioned as a means for providing communication from the user to the broadcast source, but merely in terms as a means of transmitting inputs from the user such as answers to questionnaire contests featured on a current television or radio broadcast. Such access for such purposes requires the use of a special “PassKey” card and a special card reader adaptor inserted into the user communication device (presumably required for an ATM/POS terminal as well). To further clarify, the claims referring to Internet access as a means of storing broadcast program data do not also mention use of ATM or POS terminals. They are all expressed in terms of exclusively accessing broadcast program data.

Eaton, et al (U.S. Pat. No. 6,003,019) discloses a means for a customer to request and receive financial or other services through a multi-component network which comprises devices such as telephones, a personal computer, an interactive television and possibly an ATM. The means permits the use of multiple processes such as withdrawal of money or request for a loan at the same site, with separate channels available to process each action. The system also shares data such that if, for example, a customer orders a washing machine from the communication device, this data will be shared to deduct it from their financial account, and they may be prompted whether they want to insure the washing machine, with all systems using the same customer information. Such devices may also be able to correspondingly distribute product from an associated vending machine or device. No mention is made of using existing ATM or POS equipment to distribute new products to the customer, print out financial documents at the site, nor the ability for product offerings upgraded and expanded later without the need for equipment modifications.

In summary, it is desired to provide access to the World Wide Web and Internet for users of ATM and POS terminals, and the myriad of data sources and web pages available. It is also desired to have access to pre-selected Web-based sources of information, either from a customized centralized web page or linked to common Internet sources, selected by use of screen menu buttons or keypad buttons already pre-existing on common ATM and POS terminals, to access instant sport scores, stock quotes, travel directions, weather, movie listings and show times, or other useful information. It is also desired that specific web site addresses can be entered by the terminal user by use of the existing terminal keypad. It is also desired that email can be read, composed, and sent by use of the terminal and its keypad. It is also desired that such email messages could be printed on paper by use of the pre-existing ATM paper receipt printer, as well as sports scores, weather, directions and other data. It is also desired that savings coupons related to the establishment in which the terminal is located can be printed out at the touch of a terminal menu or keypad button. It is also desired that other financial transactions can be performed and produced in paper form using the existing terminal printer, such as cashier's checks, traveler's checks, personal checks, raffle tickets, food stamps, flight insurance, show tickets and other vouchers. It is also desired that real-time communication can be maintained by use of messages typed in and printed on the screen, and responded to by printed messages sent by another individual via use of a computer or other terminal. It is also desired to have video images sent and received by use of the existing security video camera or an added camera. It is also desired to use the ATM or POS terminal as an electronic jukebox in the establishment in which it is placed, by selection of particular songs on the terminal screen menu. It is desired to collect charges for use of these features by charging them to a credit or debit card inserted into the existing magnetic card reader. It is also desired to add all or most of these features without the addition of any hardware or modifications, to minimize the costs of upgrade manpower time and equipment. It is also desired to upgrade such ATMs and POSs to increase their rate of usage per unit time, and thereby increase the profits of the owners of such ATM and POS networks (including charges for advertising time displayed on the terminal either during the initial user menu screens, or in concert with other Internet websites). No device, system or technique has been demonstrated that incorporates these features for this application.

### SUMMARY OF THE INVENTION

The principal object of the invention is to provide a means for a user to access the Internet and World Wide Web using an ATM or POS terminal.

Another object of the invention is to provide an ATM or POS user with the ability to type in specific Internet addresses and web pages to view by use of the pre-existing keypad associated with the ATM or POS terminal.

Another object of the invention is to provide an ATM or POS user the ability to access data such as sports scores, travel directions, weather, stock quotes, news, flight times, movie listings, show times and other data via the Internet by pushing a single pre-existing menu button on an ATM or POS terminal.

Another object of the invention is to provide the ability to receive and send email by use of an ATM or POS terminal and the pre-existing keypad.

Another object of the invention is to provide an ability to print email and travel/weather/schedule data by use of the pre-existing receipt printer associated with an ATM or POS terminal.

Another object of the invention is to provide an ability to perform financial transactions and print out cashier's checks, traveler's checks, personal checks, raffle tickets, food stamps, sports and show tickets by use of the pre-existing receipt printer associated with an ATM or POS terminal.

Another object of the invention is to provide an ability to print savings coupons associated within the establishment in which the ATM or POS is housed, by use of the preexisting receipt printer associated with an ATM or POS terminal.

Another object of the invention is to provide an ability to select, purchase and print flight insurance policies by use of the pre-existing receipt printer associated with an ATM or POS terminal.

Another object of the invention is to provide the user of an ATM or POS terminal with the ability to communication real time with another remote individual at a computer or ATM/POS terminal by means of alternating messages typed and sent to each other using the preexisting keypad present on the ATM or POS terminal.

Another object of the invention is to provide an ability for a user of an ATM or POS terminal to send and receive video images by means of the pre-existing video security camera or by use of a supplemental video camera.

Another object of the invention is to use an ATM or POS terminal in a retail establishment as a jukebox, with the selection of songs stored within the internal memory of the ATM/POS or available via access to the Internet through the ATM/POS terminal.

Another object of the invention is to provide the ability to collect charges for an expanded array of ATM/POS terminal services by applying those charges to the credit or debit card inserted into the pre-existing magnetic stripe card reader.

Another object of the invention is to add service enhancements to an ATM or POS terminal without the need or expense of hardware modifications to the ATM or POS terminal.

Another object of the invention is to add to the range of services offered by an ATM or POS terminal to increase the period of time in which they are in use and collecting charges, to increase their profitability to their owners (including charges for advertising time displayed on the terminal either during the initial user menu screens, or in concert with other Internet websites).

The foregoing objects can be accomplished by modifying the programming of the ATM or POS terminal in question to add these features. No hardware modifications are necessary to accomplish the desired objects. The pre-existing keypad and additional screen menu keys on the terminal can be used by the user to enter data menu choices, web addresses, or detailed email messages. The pre-existing magnetic stripe card reader can be used to collect fees charged to the user's inserted credit or debit card for each of the services used by the user, possibly on a charge-per-minute basis. The pre-existing phone line connection normally used to connect to bank and credit card processors can be used to connect and obtain access to the World Wide Web and the Internet. The pre-existing receipt printer can be used to print email messages or other paper vouchers of value. A pre-existing video security camera can be used to conduct video teleconferencing, or an additional video camera can be incorporated. If the terminal already has a speaker, then it can be programmed to be used as a jukebox for use in a retail establishment such as a restaurant or club. The terminals can be programmed to offer instant access to information such as weather, sports scores, stock quotes, flight schedules or directions with the push of one button from the screen menu buttons or keypad. The keypad can be used to enter numeric characters or alphabetic characters by an assignment of such characters to the various keypad buttons, such as is done with a telephone. When pre-selected data sources are requested, users can be directed to either popular web sites that feature such data, or a centralized web site operated by the ATM/POS network owners or an assignee. On-screen advertisements during initial user operations, or after connections onto subsequent Internet addresses, can serve as additional revenue sources for the ATM/POS network owner. The ATM or POS can be programmed to permit connection to financial institutions to facilitate the purchase, acceptance and printout of personal, cashier's or traveler's checks, flight insurance, or raffle tickets, food stamps, show tickets and other documents, having such documents printed out using the preexisting terminal receipt printer. The user of the ATM/POS terminal can communicate real-time with another individual at another computer or ATM/POS terminal by means of alternate messages typed and sent to each other. The software upgrades required to add these features are well known to those skilled in the art, and offer the potential for owners of existing ATM and POS networks to increase the traffic flow and rate of usage of their terminals, and increase their overall revenues and profits. These enhanced design features can satisfy all of the objects stated previously, whereas prior art cannot satisfy all of the objects in their entirety.

### BRIEF DESCRIPTION OF THE DRAWINGS

FIG. 1 is a front elevation view of a representative automated teller machine (ATM) or Point-Of-Sale (POS) terminal.

### DETAILED DESCRIPTION

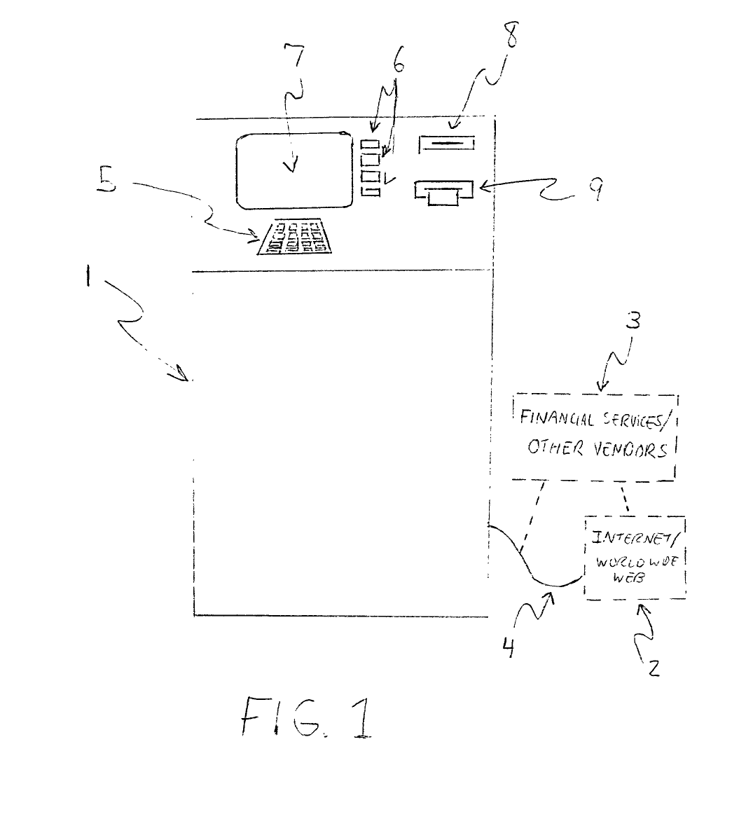

Refer now to FIG. 1, which is a drawing of an Automated Teller Machine/Point-Of-Sale terminal 1 of interest in the preferred embodiment. The terminal 1 is electronically reprogrammed to offer an improved and wider range of services available to the user. The terminal 1 is programmed to obtain access to the Internet 2, and the World Wide Web, in addition to other non-Internet connections such as to other commerce partners 3, through the existing telephone line 4 already used to establish traditional ATM/POS connections. The ability to establish interaction with any of the many Internet service providers (ISPs) currently available, and the means to call and connect to the Internet 2 at the site of the terminal 1, is well within the ability of many skilled in the art of the basics of electronic communications equipment and computer network administration.

A user can access such information at the ATM/POS terminal 1 by pushing buttons that make up the pre-existing ATM/POS keypad 5 (where ATM/POS users typically enter their personal identification codes and amounts for withdrawal) or the supplemental menu buttons 6 next to the view screen 7 (which are normally used to select the type of transaction required and account type accessed). The transaction process is initiated by the user inserting their credit, debit or ATM card into the magnetic strip card reader 8. Charges for any services rendered will be assessed to the account associated with the card used. Such charges may be assessed on a “per minute” basis to pro-rate to the period of access to services. The card may also be used as a means of confirming the identification of the user, required for several services such as email retrieval.

A terminal user can obtain access to information at the terminal by the selection of particular menu buttons on the keypad 5 or supplemental menu buttons 6. Such buttons would correspond to choices on the screen 7, such as “Weather”, “Sports Scores”, “News”, “Flight Schedules”, “Stock Quotes” and other choices. The Internet sites containing such information to which the terminal 1 connects can be popular Internet sites featuring such information, or a dedicated web site developed exclusively for ATM/POS network access, through an arrangement with an ISP and a single or group of ATM/POS network owners. The user may also may able to connect to a specific Internet address and web site of their choosing by entering the web address using the keypad 5 to type in specific characters into the screen web URL address line location. As an example, a selection of one of the menu buttons 6 can be to “type in a response”, which results in another menu of choices. A video keypad that resembles the ATM/POS keypad 5 will also appear on the screen 7, with three letters as well as a number overlaid on the image of each key, in the arrangement of a telephone keypad. If “type a web address” selection is chosen, then the user can fill in their desired web address to view by typing in the address using the keypad 5 keys and observing the screen keypad. The supplemental keypad keys, such as those on either side of the numeral “zero”, can be used to scroll up or down to select which one of the three letters is desired which are assigned to each key. The “enter” key normally also present with the keypad 5 can be used to enter a response. On-screen advertising displayed on the main menu pages, dedicated web sites or other Internet sites accessed by the user may serve as additional sources of revenue to the ATM/POS network owner.

Another choice may be to “read email”. In this instance, the user's email address would be entered. As a result they would receive a listing of the email recently sent to that address, to be viewed on the screen 7. Responses could be typed and sent using the keypad 5 as described previously. Email could also be printed out using the ATM/POS receipt printer 9 already present with the terminal. Other data derived from the general information screens could also be printed out for retention, if the web sites from which such data is downloaded has been formatted to print to the normal width of paper receipts. Stock quotes, sports scores, directions and flight times would be practical data types to print out in such a way.

The user could also download other financial documents from the terminal 1, when directed through a “financial services” screen menu. This service could be provided from a direct link to the financial institution 3, or connected through the Internet 2. Such items which could be ordered and printed out, in a legal form once the printer has been programmed correctly, could include cashier's checks, traveler's checks, personal checks, raffle tickets, food stamps, show tickets and other vouchers. Other transactions, such as the purchase of flight insurance, could be performed at the ATM/POS terminal in the airport, with the policy printed out at that site. Paper security features such as water marks, safety background printing and other techniques could be employed to facilitate usage of these products using the terminal's printer 9. If the terminal is placed within a restaurant or other retail establishment, discount coupons for the establishment (or local entertainment and amusement parks) could also be printed out, as part of an advertising campaign and arrangement between the establishment owner and the ATM/POS network owner.

One variant of the email arrangement would allow the terminal user and another individual at a remote site, via either another ATM/POS terminal or a computer, to communicate back and forth in real time by the means of typing and sending messages alternatively to be seen over the terminal screen 7. Such techniques are used in abundance currently on the Internet in common “chat rooms” and in customer service web sites for companies. This would allow young people, travelers, or business associates to alert others where they are and to communicate back and forth, if telephone connection might not be otherwise possible.

The commonly present video security camera may permit the possibility of direct video communications, either in formal video teleconferencing, or the sending of video stills, either alone or attached to an email message. Such a feature might require minor hardware modifications to merge the video signal in digital form to the ATM/POS telephone line 4.

If the ATM/POS terminal 1 has a speaker (such as might be common in some networks), then it might be possible to have it serve as an “electronic jukebox” in establishments such as restaurants and clubs. The menu 6 keys and keypad 5 could be used to cycle through song menus and direct choices, and search by title and artist. Such music could be downloaded, transmitted and broadcast in the popular MP3 digital format, either from some dedicated memory site or web address, or other places on the Internet. With this approach, a virtually infinite supply of songs is available at any site.

All of these changes can be made by direct computer software changes. These can be done typically at the centralized site of management of the ATM/POS network, and broadcast to each terminal in the network to update it. This is currently a common means of upgrading the operating software of such terminals. Features could be added gradually over time, and removed if not shown to be popular at some sites. The greatly enhanced range of services should greatly increase the period of time in which a given terminal is in use and generating revenue. In addition, the potential for users to spend a greater period of time at a terminal, being charged at a rate per minute, could greatly increase the profitability of an ATM/POS network.

There is thus described novel techniques and features to expand the range of service, period of activity and total revenue generation of a single and network of ATM/POS terminals, which meets all of its stated objectives and which overcomes the disadvantages of existing techniques.

The foregoing description of the preferred embodiments of the invention has been presented for purposes of illustration and description. It is not intended to be exhaustive or limit the invention to the precise form disclosed. Many modifications and variations are possible in light of the above teaching. It is intended that the scope of the invention be limited not by this detailed description, but rather by the claims appended hereto.

I claim:

1. A means for access to data on the Internet, World Wide Web and other financial institutions by use of an automated teller machine (ATM) or Point-of-Sale (POS) terminal, comprising:
an ATM or POS terminal;
an ATM/POS terminal keypad;
an ATM/POS terminal screen;
a series of ATM/POS terminal screen menu keys;
means of connection to telephone or other data transmission lines; electronic programming code suitable for interpreting keypad entries and obtaining electronic connection to remote Internet and other database sources;
whereby, upon the activation of a particular series of said keypad or said menu keys of said ATM or POS terminal, said terminal is connected to said Internet, database or said financial institution, facilitating the display of data from such sources on the terminal screen of said terminal.

2. The system according to claim 1, wherein fees for such access are charged to one of a group of financial cards used in an ATM/POS terminal magnetic strip card reader, comprising a credit card, a debit card, an ATM card or a special access card.

3. The system according to claim 1, wherein said terminal requires no additional physical hardware or modifications to said terminal.

4. The system according to claim 1, wherein said terminal screen features a menu selection from a group of selections, comprising sports scores, weather, stock quotes, travel directions, flight schedules, email access, real-time communication, song selection, Internet access, financial services, movie listings, movie times, show listings and show times, whereby upon selection of said menu item by selection of associated screen menu key, connection is made to a database in a group of databases comprising the Internet, a financial service database, and a private database controlled by an ATM/POS network, and displays data in said database associated with the topic of said menu selection on said screen.

5. The system according to claim 1, wherein said screen can display an image of said keypad with the addition of letters on said keypad's keys in the arrangement of a telephone keypad.

6. The system according to claim 1, wherein said keypad facilitates the entering of alphanumeric data to initiate connection at said terminal to a specific web site associated with the URL address typed in.

7. The system according to claim 4, wherein selection of a menu choice using said keypad facilitates the downloading, listing, display and review of email messages associated with said terminal's user email account on said screen, and the ability to compose content for email messages to be sent using said keypad alphanumeric entries, and the sending of said composed email messages to remote email addresses.

8. The system according to claim 4, wherein selection of a menu choice using said keypad facilitates the capability for the user of said terminal to type in messages using said keypad and transmit them to a remote viewer for viewing at another ATM/POS or computer terminal, with the ability for said remote viewer to type in an alphanumeric message and transmit it to be seen at said user's terminal screen.

9. The system according to claim 4, further comprising an audio speaker, wherein selection of a menu key corresponding to said menu selection “song selection” facilitates the display of songs available for downloading from said Internet and other said database sites, whereby upon selection of a particular song displayed by the selection of an associated menu or keypad key, said song in the form of a digital file will be downloaded to said terminal from said database and execute said file to be transmitted from said speakers.

10. The system according to claim 4, wherein selection of a menu key corresponding to said menu selection “insurance policy” facilitates the display of data pertaining to insurance policies available for purchase at the terminal site, and information required for entry to confirm acceptance of policy coverage; whereby upon entry of required user personal data, said data is transmitted electronically to said financial institution, and upon acceptance for coverage by said institution, said confirmation of coverage is transmitted to user for display to said terminal screen.

11. The system according to claim 1, wherein said screen displays advertising data.

12. A means for access to data on the Internet, World Wide Web and other financial institutions by use of an automated teller machine (ATM) or Point-of-Sale (POS) terminal, comprising:
an ATM or POS terminal;
an ATM/POS terminal keypad;
an ATM/POS terminal screen;
a series of ATM/POS terminal screen menu keys;
a receipt printer interconnected to said terminal;
means of connection to telephone or other data transmission lines;
electronic programming code suitable for interpreting keypad entries and obtaining electronic connection to remote Internet and other database sources, and printing in a format suitable for said terminal's printer;
whereby, upon the activation of a particular series of said keypad or said menu keys of said ATM or POS terminal, said terminal is connected to said Internet, database or said financial institution, facilitating the display of data from such sources on the terminal screen of said terminal, and said data is printed to paper by means of said receipt printer.

13. The system according to claim 12, wherein said data printed is one of a group of data types comprising sports scores, weather, stock quotes, travel directions, flight schedules, email messages, movie listings, movie times, show listings and show times.

14. The system according to claim 12, wherein said paper comprises one of a group comprising a cashier's check, a traveler's check, a personal check, a raffle ticket, a food stamp, a coupon, a show ticket, a movie ticket, and an insurance policy.

15. A means for access to data on the Internet, World Wide Web and other financial institutions by use of an automated teller machine (ATM) or Point-of-Sale (POS) terminal, comprising:
an ATM or POS terminal;
an ATM/POS terminal keypad;
an ATM/POS terminal screen;
a video camera;
a series of ATM/POS terminal screen menu keys;
means of connection to telephone or other data transmission lines;
electronic programming code suitable for interpreting keypad entries and obtaining electronic connection to remote Internet and other database sources, and transmitting, receiving and displaying video images in digital form;
whereby, upon the activation of a particular series of said keypad or said menu keys of said ATM or POS terminal, said terminal is connected to said Internet, database or said financial institution, facilitating the display to said screen of visual data from a remote site comprising video data, and the digital transmission of images from said video camera to said remote site.

16. The system according to claim 15, wherein said video camera is a security video camera of said terminal.

17. The system according to claim 15, wherein said video camera is not the security video camera of said terminal.

18. The system according to claim 15, wherein said remote site is another ATM/POS terminal.

19. The system according to claim 15, wherein said remote site is a computer.
